(19) United States
(12) Patent Application Publication
(10) Pub. No.: US 2008/0316645 A1
(43) Pub. Date: Dec. 25, 2008

(54) PERPENDICULAR MAGNETIC RECORDING HEAD AND METHOD OF MANUFACTURING THE SAME

(75) Inventor: Kyusik SIN, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/933,449

(22) Filed: Nov. 1, 2007

(30) Foreign Application Priority Data
Jun. 25, 2007 (KR) 10-2007-00062490

(51) Int. Cl. G11B 5/17

(52) U.S. Cl. 360/123.02

(57) ABSTRACT

Provided is a perpendicular magnetic recording head and a method of manufacturing the same. The perpendicular magnetic recording head that includes a main pole, a return yoke, and a return yoke tip, wherein the main pole and the return yoke tip that faces the main pole with a gap therebetween have the same width in a cross-track direction, and the method comprises: (a) sequentially forming a first magnetic layer for forming the main pole, the non-magnetic layer for forming a gap between the main pole and the return yoke tip, and a second magnetic layer for forming the return yoke tip; (b) patterning the second magnetic layer so that the second magnetic layer contacts the non-magnetic layer as much as a predetermined throat height; (c) forming the main pole and the return yoke tip by trimming the second magnetic layer and the first magnetic layer in a shape having the same width in the cross-track direction; and (d) forming a return yoke on the second magnetic layer.

### CROSS-REFERENCE TO RELATED PATENT APPLICATION

This application claims the benefit of Korean Patent Application No. 10-2007-0062490, filed on Jun. 25, 2007, in the Korean Intellectual Property Office, the disclosure of which is incorporated herein in its entirety by reference.

### BACKGROUND OF THE INVENTION

1. Field of the Invention

The present invention relates to a perpendicular magnetic recording head and a method of manufacturing the same, and more particularly, to a perpendicular magnetic recording head characterized in that a width of a main pole tip in a cross-track direction and a width of a return yoke tip in the cross-track direction match each other and a method of manufacturing the perpendicular magnetic recording head.

2. Description of the Related Art

Magnetic recording methods can be classified into longitudinal magnetic recording methods and perpendicular magnetic recording methods. In a longitudinal magnetic recording method, information is recorded based on a magnetization direction of a magnetic layer that is parallel to a surface of the magnetic layer, and in a perpendicular magnetic recording method, information is recorded based on a magnetization direction of a magnetic layer that is perpendicular to the surface of the magnetic layer. In terms of recording density, the perpendicular magnetic recording method is superior to the longitudinal magnetic recording method, and thus, various perpendicular magnetic recording heads have been developed.

FIG. 1A is a cross-sectional view of a conventional perpendicular magnetic recording head 10. Referring to FIG. 1A, the conventional perpendicular magnetic recording head 10 includes a recording head unit W that includes a main pole 50, a return yoke 60, a sub-yoke 40, and coils C and a reproducing head unit R that includes two magnetic shield layers 30 and a magnetoresistance device 20 interposed between the two magnetic shield layers 30. The coils C surround the main pole 22 and the sub-yoke 28 in a solenoid shape, and when a current is applied to the coils C, the main pole 50, the sub-yoke 40, and the return yoke 60 form a magnetic path of a magnetic field. The magnetic path that proceeds towards a recording medium (not shown) from the main pole 50 magnetizes a recording layer of the recording medium in a vertical direction and returns to the return yoke 24 and thus, recording is performed. The magnetoresistance device 20 can read information recorded in the recording medium by the characteristics of changing electrical resistance by a magnetic signal generated from the magnetization of the recording layer.

FIGS. 1B and 1C are views of the conventional perpendicular magnetic recording head seen from ABS of FIG. 1A, and show the return yokes 60 that have different shapes from each other when the main pole 50 is manufactured using a plating process and a vacuum deposition process. With regard to the case described in FIG. 1B, after plating the main pole 50 in a shape to be manufactured, an insulating material 70 is entirely formed above the main pole 50 so that a gap g can be formed with respect to the return yoke 60, and after the insulating material 70 is planarized using a chemical mechanical polishing (CMP) process, the return yoke 60 is formed on the planarized insulating material 70. With regard to the case in FIG. 1C, the main pole 50 is manufactured using a vacuum deposition method. In the case of forming a magnetic layer to form the main pole 50 using the vacuum deposition method, the main pole 50 having increased magnetic characteristics and increased saturation magnetic flux density Bs can be manufactured. Thus, the manufacture of the main pole 50 using the vacuum deposition method is considered as appropriate to manufacture a high density perpendicular magnetic recording head. However, this method has the following problems. Referring to FIG. 1C, after vacuum depositing a magnetic layer 50′ to form the main pole 50 and forming the insulating material 70 to form the gap g above the magnetic layer 50′, the main pole 50 is formed by etching the magnetic layer 50′ using a hard mask HM and polishing using a CMP process. In this process, return yoke tip 62 having a width W_{R} narrower than the width W_{M} of the main pole 50 is formed on a lower surface of the return yoke 60. The width difference between the main pole 50 and the return yoke 60 weakens a field gradient, thereby deteriorating the recording performance of the perpendicular magnetic recording head. Also, X and Y values and the asymmetry of the return yoke tip 62 that slightly vary according to manufacturing processes increase the distribution of magnetic write width (MWW), which causes yield reduction when the perpendicular magnetic recording head is manufactured.

### SUMMARY OF THE INVENTION

To address the above and/or other problems, the present invention provides a perpendicular magnetic recording head wherein widths of a main pole and a return yoke tip match each other so that the perpendicular magnetic recording head has increased recording characteristics and can be manufactured with high yield, and a method of manufacturing the perpendicular magnetic recording head.

According to an aspect of the present invention, there is provided a perpendicular magnetic recording head comprising: a main pole; a return yoke; a coil to which a current is applied so that the main pole generates a magnetic field for recording information onto a recording medium; and a return yoke tip that is formed on an end of the return yoke to face the main pole with a predetermined gap therebetween and has a width in a cross-track direction equal to a width of the main pole in the cross-track direction.

The return yoke may have a throat height equal to or greater than a throat height of the return yoke tip.

The main pole and/or the return yoke tip may be formed of a material different from the return yoke, and may be formed of a material having a saturation magnetic flux density greater than that of the return yoke.

The perpendicular magnetic recording head may further comprise a sub-yoke separated by a predetermined distance from an end of the main pole so that the magnetic field is focused on an end of the main pole corresponding to a surface of the recording medium, and the sub-yoke may be formed on upper or lower surface of the main pole The coils may be formed in a solenoid shape that surrounds the main pole, or in a plane spiral shape that surrounds the return yoke.

According to an aspect of the present invention, there is provided a method of manufacturing a perpendicular magnetic recording head that comprises: a main pole, a return yoke, and a return yoke tip, wherein the main pole and the return yoke tip that faces the main pole with a gap therebetween have the same width in a cross-track direction, the method comprising: (a) sequentially forming a first magnetic layer for forming a main pole, a non-magnetic layer for forming a gap between the main pole and the return yoke tip, and a second magnetic layer for forming a return yoke tip; (b) patterning the second magnetic layer so that the second magnetic layer contacts the non-magnetic layer as much as a predetermined throat height; (c) forming a main pole and a return yoke tip by trimming the second magnetic layer and the first magnetic layer in a shape having an identical width in the cross-track direction; and (d) forming a return yoke on the second magnetic layer.

The sequentially forming of the first magnetic layer for forming the main pole, the non-magnetic layer for forming a gap between the main pole and the return yoke tip, and the second magnetic layer for forming the return yoke tip may comprise forming the first magnetic layer using a material having a saturation magnetic flux density of 2.1 to 2.4 T, and forming the second magnetic layer using a material having a saturation magnetic flux density of 1.0 to 2.4 T.

The patterning of the second magnetic layer so that the second magnetic layer contacts the non-magnetic layer as much as a predetermined throat height may be performed using a bilayer photoresist pattern.

The forming of the main pole and the return yoke tip by trimming the second magnetic layer and the first magnetic layer in a shape having an identical width in the cross-track direction may comprise: forming a hard mask having a width corresponding to the same width on the second magnetic layer; and etching the first magnetic layer and the second magnetic layer using the hard mask as an etch mask.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic cross-sectional view of a conventional perpendicular magnetic recording head;

FIGS. 1B and 1C are views seen from an air bearing surface (ABS) of the conventional perpendicular magnetic recording head of FIG. 1A, and show different shapes of return yokes formed according to methods of manufacturing a main pole;

FIG. 2A is a schematic cross-sectional view of a perpendicular magnetic recording head according to an embodiment of the present invention;

FIGS. 2B and 2C are magnified views of portion A of FIG. 2A seen from different planes; and

FIGS. 3A through 3K are cross-sectional views illustrating a method of manufacturing a perpendicular magnetic recording head according to an embodiment of the present invention.

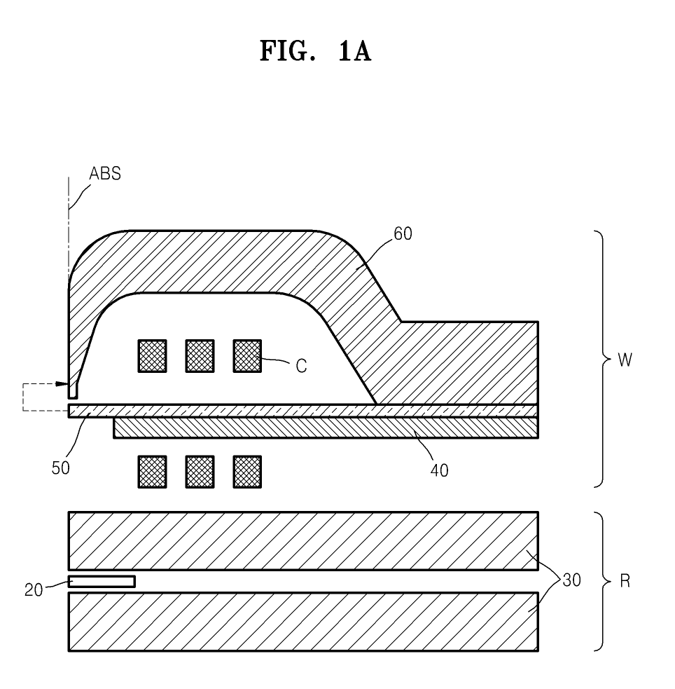

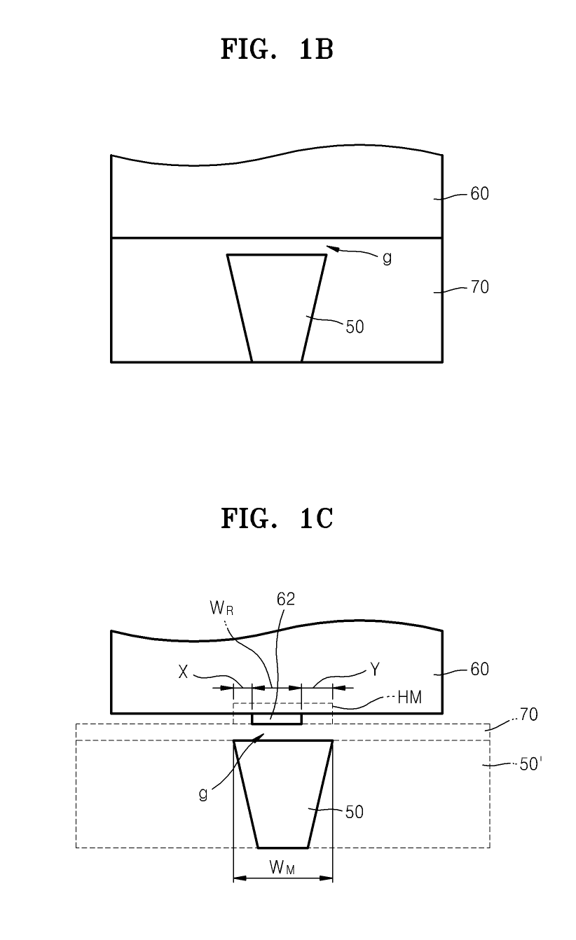

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity, and like reference numerals refer to the like elements.

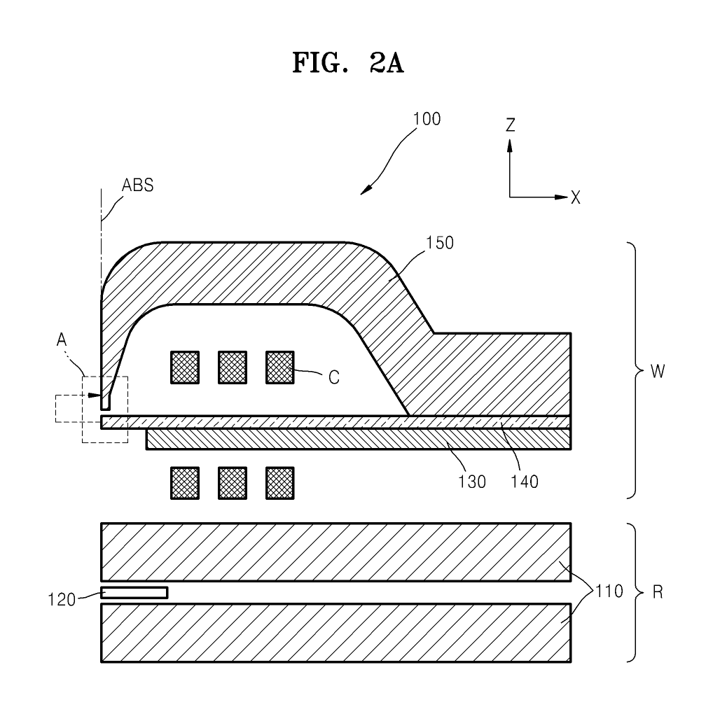

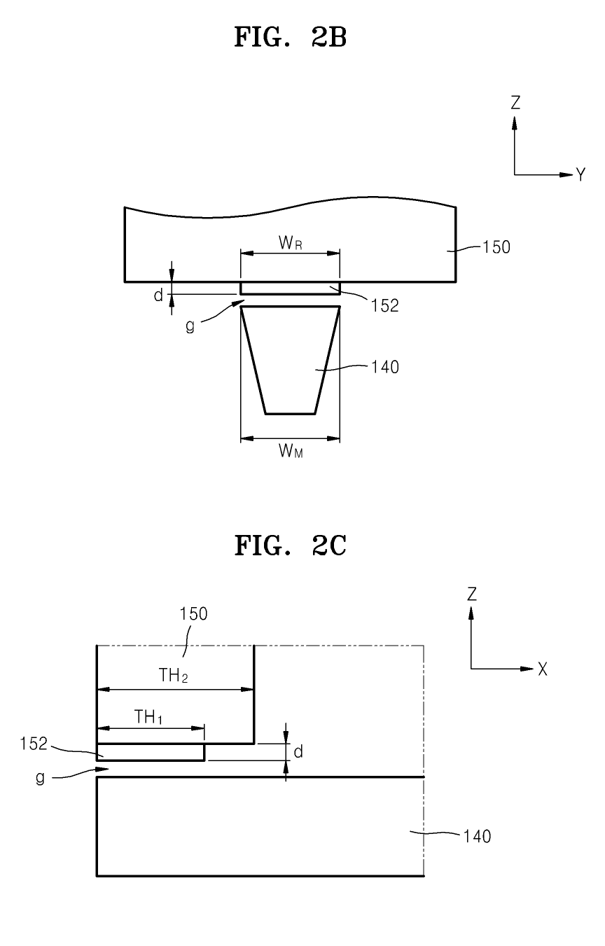

FIG. 2A is a schematic cross-sectional view of a perpendicular magnetic recording head 100 according to an embodiment of the present invention. FIGS. 2B and 2C are magnified views of portion A of FIG. 2A respectively seen from an air bearing surface (ABS) and from the same point as the cross-sectional view of FIG. 2A. Referring to FIGS. 2A, 2B, and 2C, in order to record information onto a recording medium (not shown) which is separated a predetermined distance form the ABS, the perpendicular magnetic recording head 100 includes a recording head unit W comprising a main pole 140 that generates a magnetic field towards the recording medium, coils C to which a current for generating the magnetic field is applied, and a return yoke 150 that constitutes a magnetization path of the magnetic field together with the main pole 140. The recording head unit W may further include a sub-yoke 130 so as that the magnetic flux can be concentrated on an end portion of the main pole 140 to an ABS more effectively. Also, in order to read information recorded on the recording medium, the perpendicular magnetic recording head 100 may further include a reproducing head unit R that includes two magnetic shield layers 110 and a magnetoresistance device 120 interposed between the two magnetic shield layers 110.

The sub-yoke 130 is separated away from the ABS so that the magnetic field can be focused on the end portion of the main pole 140 to the ABS. In FIG. 2A, the sub-yoke 130 is formed under the main pole 140, however, the sub-yoke 130 may be formed on the main pole 140.

The coils C surround the main pole 140 and the sub-yoke 130 three times in a solenoid shape. However, the shape of the coils C and the number of turns are just examples, and thus, the coils C may have any shape as long as they generate the magnetic field that proceeds towards the recording medium on an end portion of the main pole 140. For example, the coils C may surround the return yoke 150 in a plane spiral shape.

A return yoke tip 152 that faces the main pole 140 with a predetermined gap g therebetween is formed on an end side of the return yoke 150. The return yoke tip 152 has a width in a cross-track direction equal to a width of the main pole 140 in the cross-track direction. In FIG. 2B, Y direction corresponds to the cross-track direction. The return yoke tip 152 has a throat height TH₁ smaller than the throat height TH₂ of the return yoke 150. The throat height TH₁ of the return yoke tip 152 may be formed to be equal to the throat height TH₂ of the return yoke 150. However, if the throat height TH₁ of the return yoke tip 152 is increased beyond an optimum height, it is disadvantageous for recording information since the amount of magnetic flux of the main pole 140 that proceeds towards the return yoke 150 through the gap g without passing through the recording medium is increased. Therefore, the throat height TH₁ of the return yoke tip 152 may be formed shorter, and the throat height TH₂ of the return yoke 150 may be formed greater than the throat height TH₁ of the return yoke tip 152 when considering the overall shape of the return yoke 150. The return yoke tip 152 may be formed to have a depth d of approximately 50 nm or less.

The main pole 140, the return yoke tip 152, the return yoke 150, and the sub-yoke 130 are formed of magnetic materials so that a magnetic path of the magnetic field generated by the coils C can be formed. At this point, since the magnitude of the magnetic field focused on the end of the main pole 140 is limited by the saturation magnetic flux density Bs, the main pole 140 is formed of a material having a saturation magnetic flux density Bs greater than the return yoke 150 or the sub-yoke 130. For example, the main pole 140 can be formed of NiFe, CoFe, or CoNiFe. The sub-yoke 130 and the return yoke 150 may be formed to have a magnetic permeability relatively higher than that of the main pole 140 so that the sub-yoke 130 and the return yoke 150 can have a rapid response characteristic in response to the variation of magnetic field at high frequency. The sub-yoke 130 and the return yoke 150 are mainly formed of a magnetic material such as NiFe, and at this point, the saturation magnetic flux density Bs and the magnetic permeability can be appropriately designed by controlling the component ratio of Ni and Fe. The return yoke tip 152 can be formed of the same material as the return yoke 150 or a material different from the return yoke 150. The return yoke tip 152 can be formed of a material having a saturation magnetic flux density Bs of 1.0 to 2.4 T. In the structure of the perpendicular magnetic recording head 100, since the return yoke tip 152 focuses magnetic flux in a relatively small space, the return yoke tip 152 may be formed of a magnetic material having a saturation magnetic flux density Bs greater than that of the return yoke 150 or the sub-yoke 130.

The perpendicular magnetic recording head 100 having the above structure has a field gradient better than that of a perpendicular magnetic recording head in which the return yoke tip 152 is not formed or the return yoke tip 152 has a width in the cross-track direction smaller than the width of the main pole 140 in the cross-track direction. Therefore, the perpendicular magnetic recording head 100 forms a recording bit having a sharp transition characteristic when information is recorded onto a recording medium.

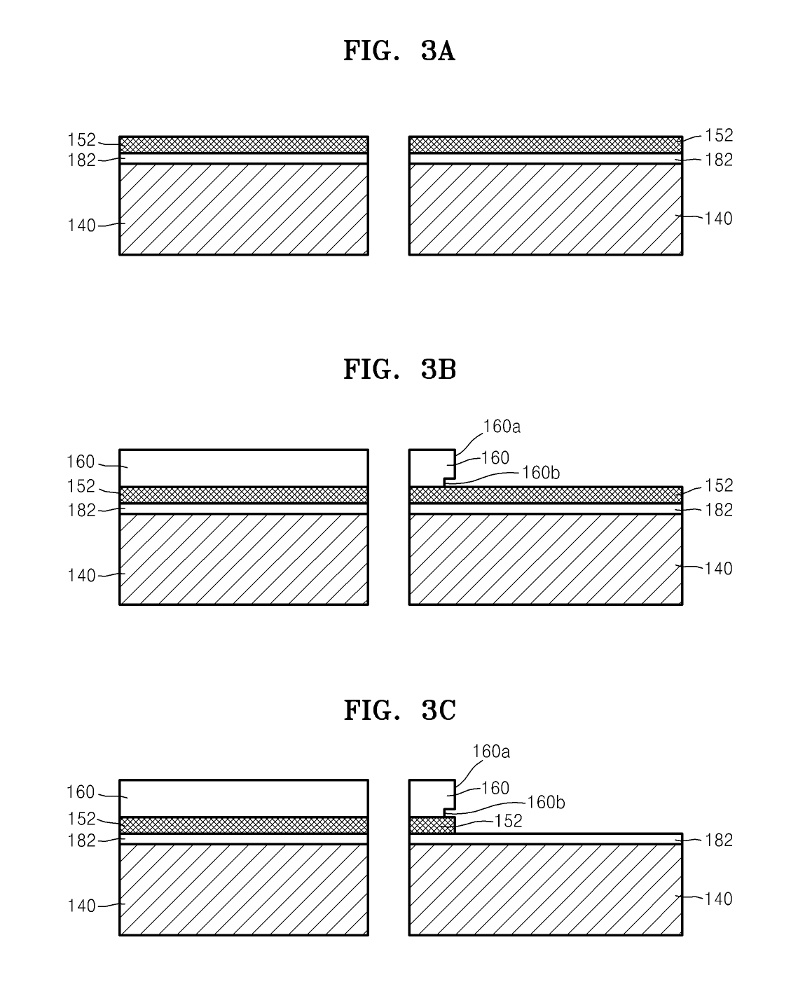

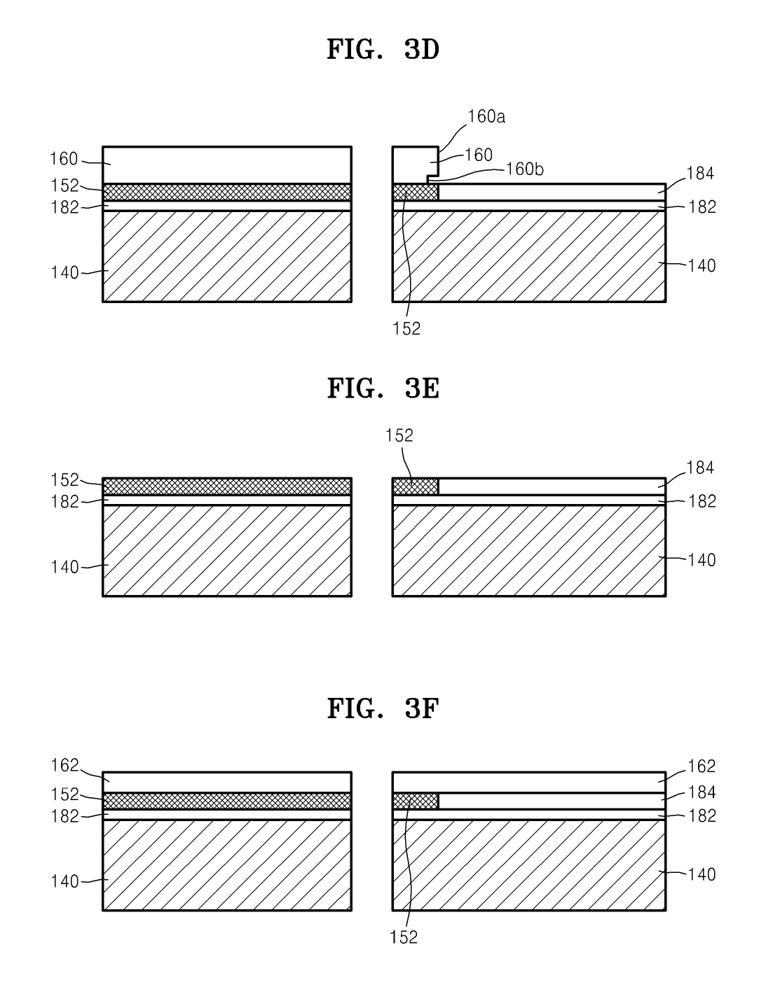

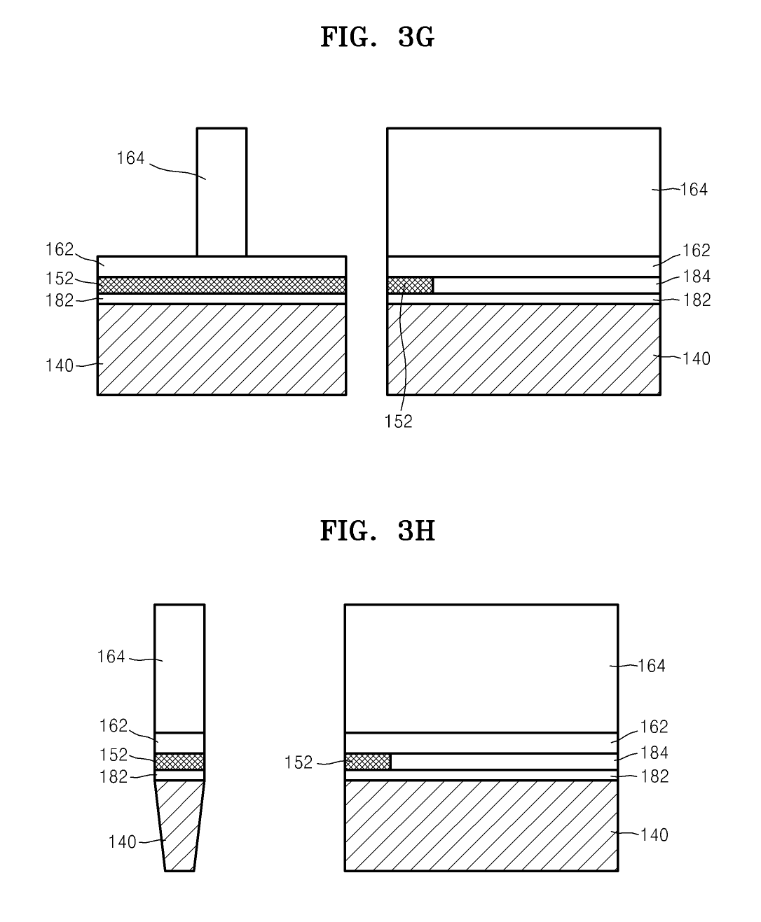

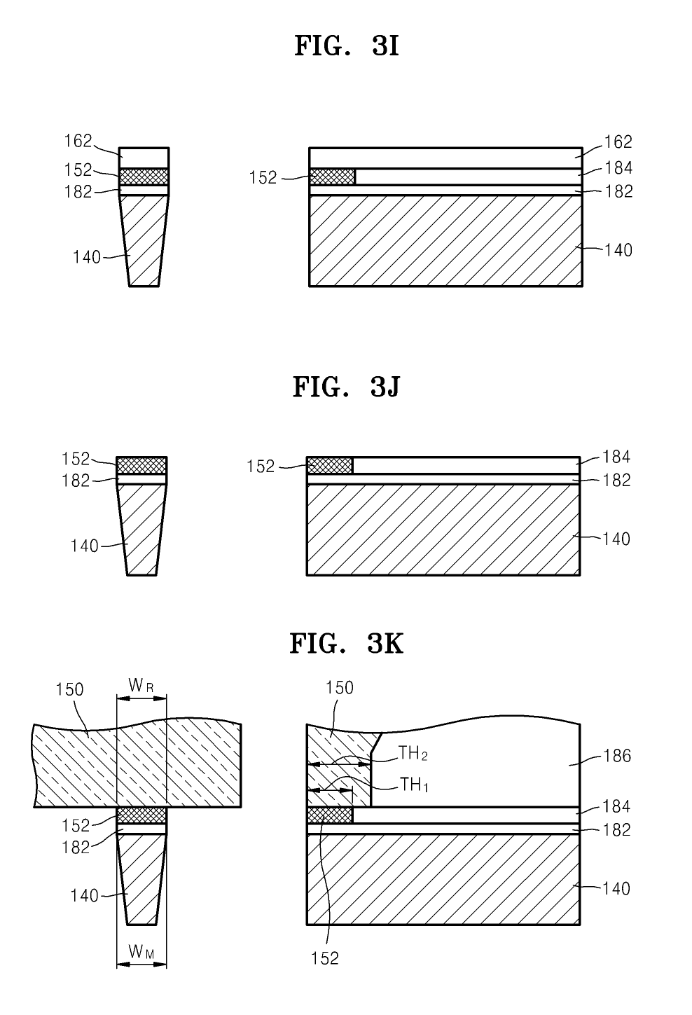

A method of manufacturing the perpendicular magnetic recording head according to the present invention will now be described with reference to FIGS. 3A through 3K which show magnified views of portion A of FIG. 2A. In each figure, the left side view is a cross-sectional view seen from the ABS, that is, a view seen from a YZ plane, and the right side view is a cross-sectional view seen from an XZ plane.

Referring to FIG. 3A, a first magnetic layer 140 for forming a main pole, a non-magnetic layer 182 for forming a gap between the main pole 140 and a second magnetic layer 152, and the second magnetic layer 152 for forming a return yoke tip are sequentially formed. The first magnetic layer 140 can be formed by vacuum deposition of a material having high saturation magnetic flux density Bs. For example, the first magnetic layer 140 can be formed to have a saturation magnetic flux density Bs of 2.1 to 2.4 T using NiFe, CoFe, or CoNiFe. In FIG. 3A, the first magnetic layer 140 has a single layer structure. However, the first magnetic layer 140 can be formed in a multilayer structure such as a magnetostatical coupling structure or an antiferromagnetic coupling (AFC) structure. The non-magnetic layer 182 can be formed by vacuum depositing a non-magnetic metal such as Ta, Cr, or Ru or a dielectric material such as Al₂O₃, AlN, SiO₂, or SiN. The second magnetic layer 152 can also be formed by vacuum deposition using a material having a saturation magnetic flux density Bs of 1.0 to 2.4 T.

FIGS. 3B through 3E are cross-sectional views illustrating a process of patterning the second magnetic layer 152 so that the second magnetic layer 152 can have a shape contacting the non-magnetic layer 182 as much as a predetermined throat height. For example, referring to FIG. 3B, a photoresist 160 having a predetermined pattern is formed on the second magnetic layer 152. For example, as depicted in FIG. 3B, the photoresist pattern 160 can be a bi-layer photoresist pattern. The purpose of forming the photoresist 160 in the bi-layer photoresist pattern is to avoid the difficultness of removing the photoresist 160 from side surfaces 160a and 160b of the photoresist 160 due to the contamination of the side surfaces 160a and 160b with etched debris during the etching process. Referring to FIG. 3C, the second magnetic layer 152 is etched using the photoresist 160 as a mask. At this point, some portions of the etched materials can contaminate the side surfaces 160a and 160b of the photoresist 160. The concaved surface 160b of the photoresist 160 is relatively less contaminated by the etched materials compared to the protruded surface 160a of the photoresist 160. Thus, a resist stripping solution for lifting off the photoresist 160 can readily penetrate the bi-layer photoresist pattern. In FIG. 3C, a portion of the second magnetic layer 152 is etched and the non-magnetic layer 182 is not etched. However, a portion of the non-magnetic layer 182 can also be etched when the second magnetic layer 152 is etched. Referring to FIG. 3D, a first insulating layer 184 is formed in a region where a portion of the second magnetic layer 152 is etched using, for example, Al₂O₃, AlN, SiO₂, or SiN. When the photoresist 160 is removed from the resultant product of FIG. 3D, a structure as depicted in FIG. 3E is formed. At this point, as described above, even if contamination of the side surfaces 160a and 160b of the photoresist 160 occurs, the protruded surface 160a of the photoresist 160 is mostly contaminated by etched materials, and thus the resist stripping solution can readily penetrate into the concaved surface 160b of the photoresist 160, thereby readily removing the photoresist 160.

FIGS. 3F through 3J are cross-sectional views illustrating a method of manufacturing a main pole and a return yoke tip by trimming the second magnetic layer 152 and the first magnetic layer 140 into a shape having the same width in a cross-track direction. Referring to FIG. 3F, a polishing stop layer 162 is formed on the second magnetic layer 152. The polishing stop layer 162 is formed of a material that is not polished by a CMP process, for example, it can be formed by depositing Ta or diamond like carbon (DLC). Referring to FIG. 3G, a hard mask 164 is formed on the polishing stop layer 162. The hard mask 164 is formed to have a width equal to the cross-track directional width of a main pole and a return yoke tip to be manufactured using photoresist, Al₂O₃, or SiN. The etching rate of the material used to form the hard mask 164 may be lower than that of the first magnetic layer 140. Referring to FIG. 3H, the first magnetic layer 140, the non-magnetic layer 182, the second magnetic layer 152, and the polishing stop layer 162 are etched using the hard mask 164 as an etch mask. Referring to FIG. 3I, the hard mask 164 is polished using a CMP process. When the polishing stop layer 162 is removed, a shape as depicted in FIG. 3J is formed. The polishing stop layer 162 can be removed by, for example, reactive ion etching (RIE).

Referring to FIG. 3K, a second insulating layer 186 is formed on the first insulating layer 184, and a return yoke 150 is formed on the second magnetic layer 152. The second insulating layer 186 can be formed of, for example, Al₂O₃, AlN, SiO₂, or SiN. The return yoke 150 can be formed of NiFe. The return yoke 150 can be formed to have a throat height TH₂ equal to or greater than the throat height TH₁ of the second magnetic layer 152 which corresponds to the return yoke tip. Although not shown, coils are formed on the first insulating layer 184, and the second insulating layer 186 is generally formed to cover the coils. The return yoke 150 can be formed after forming the second insulating layer 186. Alternatively, after forming a portion of the return yoke 150, the second insulating layer 186 is formed. Afterwards, the rest portion of the return yoke 150 can be formed. The throat height TH₂ of the return yoke 150 is determined when the second insulating layer 186 is patterned or during the forming of a portion of the return yoke 150. In either case, since the throat height TH₁ of the second magnetic layer 152 that mainly affects the recording characteristics of the perpendicular magnetic recording head is already formed, the throat height TH₂ of the return yoke 150 can be determined appropriately according to the convenience of process without affecting the throat height TH₁ of the second magnetic layer 152. Through the above process, the width W_{M} of the first magnetic layer 140 in the cross-track direction that corresponds to a main pole and the width W_{R} of the second magnetic layer 152 in the cross-track direction are formed equal to each other.

As described above, in a perpendicular magnetic recording head according to the present invention, a return yoke tip and a main pole are formed to have the same width in a cross-track direction. Thus, the reduction of a field gradient due to a width difference between the return yoke tip and the main pole can be prevented, and the productivity can be increased by reducing the distribution of magnetic recording width.

Also, in a method of manufacturing the perpendicular magnetic recording head according to the present invention, in order to manufacture the main pole and the return yoke tip to have the same width in the cross-track direction, after forming magnetic layers for forming a main pole and a return yoke tip, respectively, the main pole and the return yoke tip are formed by etching in the same process. Thus, the main pole and the return yoke tip having a width in the cross-track direction can be readily formed. Also, since the magnetic layer for forming the main pole can be formed using a vacuum deposition method, the perpendicular magnetic recording head is advantageous for high density recording. Also, since the return yoke tip and the return yoke are formed in separated processes from each other, a return yoke tip having a short throat height can be manufactured more easily.

While a perpendicular magnetic recording head and a method of manufacturing the same according to the present invention have been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A perpendicular magnetic recording head comprising:
a main pole;
a return yoke;
a coil to which a current is applied so that the main pole generates a magnetic field for recording information onto a recording medium; and
a return yoke tip that is formed on an end of the return yoke to face the main pole with a predetermined gap therebetween and has a width in a cross-track direction equal to a width of the main pole in the cross-track direction.

2. The perpendicular magnetic recording head of claim 1, wherein the return yoke has a throat height equal to or greater than a throat height of the return yoke tip.

3. The perpendicular magnetic recording head of claim 1, wherein the return yoke tip is formed of a material different from the return yoke.

4. The perpendicular magnetic recording head of claim 1, wherein the main pole and/or the return yoke tip are/is formed of a material having a saturation magnetic flux density greater than a saturation magnetic flux density of the return yoke.

5. The perpendicular magnetic recording head of claim 1, further comprising a sub-yoke separated by a predetermined distance from an end of the main pole so that the magnetic field is focused on an end of the main pole facing the recording medium.

6. The perpendicular magnetic recording head of claim 5, wherein the main pole has a saturation magnetic flux density greater than a saturation magnetic flux density of the sub-yoke.

7. The perpendicular magnetic recording head of claim 5, wherein the sub-yoke is formed on upper or lower surface of the main pole.

8. The perpendicular magnetic recording head of claim 1, wherein the coil have a solenoid shape that surrounds the main pole.

9. The perpendicular magnetic recording head of claim 1, wherein the coil have a plane spiral shape that surrounds the return yoke.

10. A method of manufacturing a perpendicular magnetic recording head that comprises: a main pole, a return yoke, and a return yoke tip, wherein the main pole and the return yoke tip that faces the main pole with a gap therebetween have the same width in a cross-track direction, the method comprising:
(a) sequentially forming a first magnetic layer for forming the main pole, a non-magnetic layer for forming a gap between the main pole and the return yoke tip, and a second magnetic layer for forming the return yoke tip;
(b) patterning the second magnetic layer so that the second magnetic layer contacts the non-magnetic layer as much as a predetermined throat height;
(c) forming the main pole and the return yoke tip by trimming the second magnetic layer and the first magnetic layer in a shape having the same width in the cross-track direction; and
(d) forming the return yoke on the second magnetic layer.

11. The method of claim 10, wherein the sequentially forming of the first magnetic layer for forming the main pole, the non-magnetic layer for forming a gap between the main pole and the return yoke tip, and the second magnetic layer for forming the return yoke tip comprises vacuum depositing the first magnetic layer and the second magnetic layer.

12. The method of claim 10, wherein the sequentially forming the first magnetic layer for forming the main pole, the non-magnetic layer for forming a gap between the main pole and the return yoke tip, and the second magnetic layer for forming the return yoke tip comprises forming the first magnetic layer using a material having a saturation magnetic flux density of 2.1 to 2.4 T.

13. The method of claim 10, wherein the sequentially forming the first magnetic layer for forming the main pole, the non-magnetic layer for forming a gap between the main pole and the return yoke tip, and the second magnetic layer for forming the return yoke tip comprises forming the second magnetic layer using a material having a saturation magnetic flux density of 1.0 to 2.4 T.

14. The method of claim 10, wherein the patterning of the second magnetic layer so that the second magnetic layer contacts the non-magnetic layer as much as a predetermined throat height comprises:
forming a bilayer photoresist pattern on the second magnetic layer;
etching the second magnetic layer using the a bilayer photoresist pattern;
forming an insulating layer on the etched region; and
removing the bilayer photoresist pattern.

15. The method of claim 10, wherein the forming of the main pole and the return yoke tip by trimming the second magnetic layer and the first magnetic layer in a shape having the same width in the cross-track direction comprises:
forming a hard mask having a width corresponding to the same width on the second magnetic layer;
etching the first magnetic layer, the non-magnetic layer, and the second magnetic layer using the hard mask as an etch mask; and
removing the hard mask.

16. The method of claim 15, wherein the hard mask is formed of one of a photoresist, Al₂O₃, and SiN.

17. The method of claim 15, wherein the material for forming the hard mask has an etch rate lower than the first magnetic layer.

18. The method of claim 15, further comprising forming a polishing stop layer on the second magnetic layer prior to forming of the hard mask.

19. The method of claim 18, wherein the polishing stop layer is formed of Ta or diamond like carbon (DLC).

20. The method of claim 18, wherein the hard mask is removed using a chemical mechanical polishing (CMP) method.

21. The method of claim 18, wherein the polishing stop layer is removed after removing the hard mask.
